(19) United States
(12) Patent Application Publication
(10) Pub. No.: US 2025/0130040 A1
(43) Pub. Date: Apr. 24, 2025

(54) APPARATUS AND METHOD FOR DETECTING ABNORMAL WHEEL ALIGNMENT

(71) Applicant: HYUNDAI MOBIS CO., LTD., Seoul (KR)

(72) Inventors: Bong Soo KIM, Yongin-si (KR); Tae Hong KIM, Yongin-si (KR)

(73) Assignee: HYUNDAI MOBIS CO., LTD., Seoul (KR)

(21) Appl. No.: 18/788,507

(22) Filed: Jul. 30, 2024

(30) Foreign Application Priority Data
Oct. 20, 2023 (KR) 10-2023-0141182

(51) Int. Cl. G01B 21/26; G01M 17/013

(52) U.S. Cl. CPC G01B 21/26; G01M 17/013

(57) ABSTRACT

Disclosed are an apparatus and method for detecting abnormal wheel alignment. The apparatus for detecting abnormal wheel alignment includes a sensor module and a processor operatively connected to the sensor module. The processor may calculate a steering angle error indicative of a difference between a target steering angle of a vehicle and a steering angle of the vehicle that has been detected based on lane information obtained by the sensor module, may calculate a rack force error indicative of a difference between a first rack force estimated based on information that has been fed back by a motor driven power steering system (MDPS) module of the vehicle and a second rack force estimated based on information including a yaw rate and lateral acceleration obtained by the sensor module, and may determine whether wheel alignment is abnormal based on at least one of the steering angle error and the rack force error.

### CROSS-REFERENCE TO RELATED APPLICATION

This application claims priority from and the benefit of Korean Patent Application No. 10-2023-0141182, filed on Oct. 20, 2023, which is hereby incorporated by reference for all purposes as if set forth herein.

### BACKGROUND

### Field

Exemplary embodiments of the present disclosure relate to an apparatus and method for detecting abnormal wheel alignment, and more particularly, to an apparatus and method for detecting abnormal wheel alignment, which detect abnormal wheel alignment in a vehicle and notify a driver of the abnormal wheel alignment or enable a driver to check the abnormal wheel alignment based on the results of an on-board diagnostic (OBD) check.

### Discussion of the Background

In general, a smart cruise control (SCC) system or a lane keep assist system (LKAS) is a system that tracks a preceding vehicle by using various sensors (e.g., a millimeter radar and a vision sensor) and prevents a lane departure attributable to a driver's carelessness (e.g., drowsiness). Mass production for the SCC system or the LKAS system are now in progress in many automobile manufacturers.

However, the systems (e.g., the SCC, an adaptive cruise control System (ACCS), and the LKAS) have a possibility that the systems may cause an accident because they cause a malfunction or sensitive operation on a road, if the systems operate when the state of a vehicle is not normal because a controller not a driver autonomously controls the steering, driving, and braking of the vehicle.

Accordingly, an automobile manufacturer specifies situations (e.g., the alignment of wheels, the installation of recommended tires, and compliance with prescribed tire pressure) that need to be checked before the systems (e.g., the SCC, the ACCS, and the LKAS) operate in an owner's manual. Each of the systems (e.g., the SCC, the ACCS, and the LKAS) essentially maintains a function for autonomously correcting the distortion or abnormality of an environment sensor (e.g., radar or a camera) that is essential for control by checking the distortion or abnormality.

In this case, in order to guarantee normal operations of the systems (e.g., the SCC, the ACCS, and the LKAS), it is very important to determine the normal state of the vehicle itself. In particular, the alignment state of wheel alignment is important. There is no method of the system autonomously checking a wheel alignment distortion in addition to a method of checking the distortion state of wheels by using technical equipment in an auto repair shop. Accordingly, performance of the systems may be degraded in a vehicle that has been out of wheel alignment.

The Background Technology of the present disclosure was disclosed in Korean Patent Application No. 10-2001-0001849 (laid open on Jan. 5, 2001 entitled “DEVICE AND METHOD FOR ALARMING WHEEL ALIGNMENT SWERVE OF CAR”).

### SUMMARY

Various embodiments are directed to providing an apparatus and method for detecting abnormal wheel alignment, which detect abnormal wheel alignment (e.g., distortion) in a vehicle and notify a driver of the abnormal wheel alignment or enable a driver to check the abnormal wheel alignment based the results of an OBD check.

In an embodiment, an apparatus for detecting abnormal wheel alignment may include a sensor module and a processor operatively connected to the sensor module. The processor determines a steering angle error including a difference between a target steering angle of a vehicle and a steering angle of the vehicle that has been detected based on lane information obtained by the sensor module, determines a rack force error including a difference between a first rack force estimated based on information that has been fed back by a motor driven power steering system (MDPS) module of the vehicle and a second rack force estimated based on information including a yaw rate and lateral acceleration obtained by the sensor module, and determines whether wheel alignment is abnormal based on at least one of the steering angle error and the rack force error.

In an embodiment of the present disclosure, the processor may detect a straight situation of the vehicle based on information on the locations of objects on a road, which have been obtained by a radar sensor of the vehicle, and the yaw rate and a steering angle obtained by the sensor module, and may determine the steering angle error based on lane information obtained by an image sensor operatively connected to the processor when the detected information of the vehicle corresponds to a straight state.

In an embodiment of the present disclosure, the processor may estimate the first rack force based on a preset equation by receiving an actual steering angle, an actual steering angular velocity, and an actual current that have been detected by the MDPS module through the sensor module.

In an embodiment of the present disclosure, the processor may estimate the second rack force by using a model equation of a preset rack force estimation model based on the yaw rate, the lateral acceleration, and a vehicle speed that have been detected by the sensor module.

In an embodiment of the present disclosure, the processor may compare the steering angle error with a preset reference steering angle error range and determines that the wheel alignment is abnormal when the steering angle error falls outside the reference steering angle error range, and may compare the rack force error with a preset reference rack force error range and determines that the wheel alignment is abnormal when the rack force error falls outside the reference rack force error range.

The apparatus may further include an alarm module. The processor may output an alarm that provides notification of the abnormal wheel alignment through the alarm module when the wheel alignment is determined to be abnormal due to the steering angle error or when the wheel alignment is determined to be abnormal due to the rack force error.

In an embodiment, a method of detecting abnormal wheel alignment may include receiving, by a processor, sensing information from a sensor module, determining, by the processor, a steering angle error including a difference between a detected steering angle and a target steering angle based on lane information included in the sensing information and determining a rack force error including a difference between a first rack force estimated based on information that has been fed back by a motor driven power steering system (MDPS) module of a vehicle and a second rack force estimated based on a yaw rate and a lateral acceleration included in the sensing information, and determining, by the processor, whether wheel alignment is abnormal based on at least one of the steering angle error and the rack force error.

In an embodiment of the present disclosure, in the determining of the rack force error, the processor may detect a straight situation of the vehicle based on information on the locations of objects on a road, which have been obtained by a radar sensor of the vehicle, and the yaw rate and a steering angle obtained by the sensor module, may determine the steering angle error based on lane information obtained by an image sensor operatively connected to the processor when the detected information of the vehicle corresponds to a straight state, may estimate the first rack force based on a preset equation by receiving an actual steering angle, an actual steering angular velocity, and an actual current that have been detected by the MDPS module through the sensor module, may estimate the second rack force by using a model equation of a preset rack force estimation model based on the yaw rate, the lateral acceleration, and a vehicle speed that have been detected by the sensor module, and may determine a rack force error between the first rack force and the second rack force.

In an embodiment of the present disclosure, in the determining of whether the wheel alignment is abnormal, the processor may compare the steering angle error with a preset reference steering angle error range and determines that the wheel alignment is abnormal when the steering angle error falls outside the reference steering angle error range, and may compare the rack force error with a preset reference rack force error range and determines that the wheel alignment is abnormal when the rack force error falls outside the reference rack force error range.

In an embodiment of the present disclosure, the method may further include outputting, by the processor, an alarm that provides notification of the abnormal wheel alignment through the alarm module when the wheel alignment is determined to be abnormal due to the steering angle error or the rack force error, after the determining of whether the wheel alignment is abnormal.

According to an embodiment of the present disclosure, whether wheel alignment (e.g., distortion) in a vehicle is abnormal is detected, and a driver is notified of the abnormal wheel alignment or can check the abnormal wheel alignment based the results of an OBD check. Accordingly, there are effects in that a driver can simply check whether wheel alignment is abnormal, can be notified of an objectively determined fault, and can repair the abnormal wheel alignment cheaply and rapidly.

Furthermore, according to an embodiment of the present disclosure, it is advantageous from a viewpoint of vehicle maintenance and repair because information on wheel alignment distortion is output by using the alarm module (e.g., a warning lamp) or an OBD fault signal is transmitted. Furthermore, there is an effect in that in autonomous driving, a burden of a vehicle manufacturer can be reduced with respect to an accident which may occur due to a corresponding fault by previously notifying a driver of a driving performance fault situation attributable to abnormal wheel alignment.

### BRIEF DESCRIPTION OF THE DRAWINGS

FIG. 1 is a diagram for describing a construction of an apparatus for detecting abnormal wheel alignment according to an embodiment of the present disclosure.

FIG. 2 is an exemplary diagram for describing a method of estimating a first rack force according to an embodiment of the present disclosure.

FIG. 3 is an exemplary diagram for describing a method of estimating a second rack force according to an embodiment of the present disclosure.

FIG. 4 is a flowchart for describing a method of detecting abnormal wheel alignment according to an embodiment of the present disclosure.

### DETAILED DESCRIPTION OF THE ILLUSTRATED EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying g computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

Hereinafter, an apparatus and method for detecting abnormal wheel alignment according to embodiments of the present disclosure will be described with reference to the accompanying drawings.

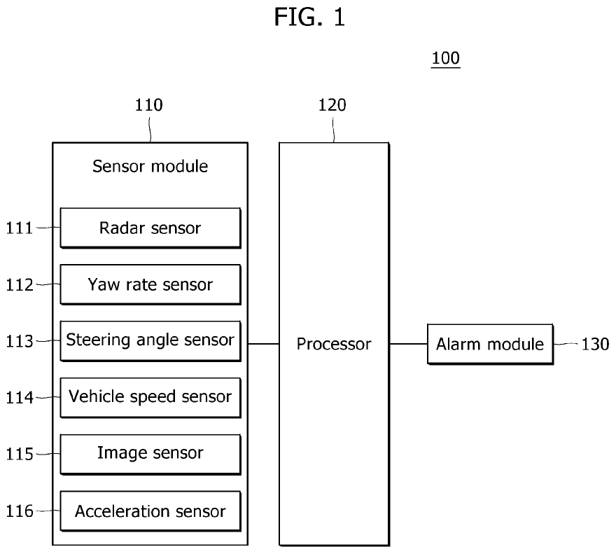

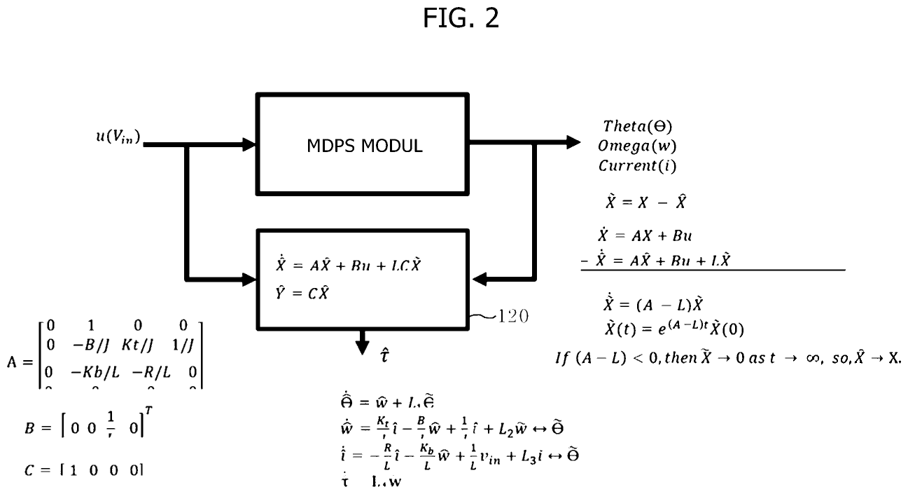

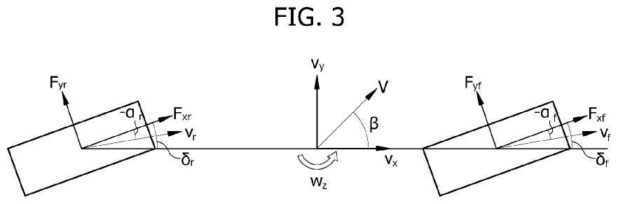

FIG. 1 is a diagram for describing a construction of an apparatus for detecting abnormal wheel alignment according to an embodiment of the present disclosure. FIG. 2 is an exemplary diagram for describing a method of estimating a first rack force according to an embodiment of the present disclosure. FIG. 3 is an exemplary diagram for describing a method of estimating a second rack force according to an embodiment of the present disclosure.

Referring to FIG. 1, an apparatus 100 for detecting abnormal wheel alignment according to an embodiment of the present disclosure includes a sensor module 110, a processor 120, and an alarm module 130.

The sensor module 110 detects driving information of a vehicle, such as a wheel speed, a yaw rate, acceleration, a steering angle, and a vehicle speed, and transmits the driving information to the processor 120.

The sensor module 110 may include a radar sensor 111, a yaw rate sensor 112, a steering angle sensor 113, a vehicle speed sensor 114, an image sensor 115, an acceleration sensor 116, and a wheel speed sensor (not illustrated).

The yaw rate sensor 112 may measure an angular speed that rotates on the basis of a vertical axis of a vehicle, that is, a yaw rate. The yaw rate sensor 112 measures an inclined yaw rate of a vehicle when the vehicle travels and provides the inclined yaw rate to the processor 120 so that the processor 120 may estimate a lateral change of the vehicle.

The steering angle sensor 113 is disposed at a lower end of a steering wheel, and may measure the steering angle of the steering wheel when a driver adjusts a handle. The driver's turning intention may be determined based on the measured speeds and angles. A front steering angle may be calculated based on the steering angle measured by the steering angle sensor 113.

The vehicle speed sensor 114 may detect the vehicle speed of a vehicle that is traveling. The vehicle speed sensor 114 may include all of various sensors, such as a sensor for detecting the vehicle speed by using the rotation speed of a wheel, a sensor for detecting the vehicle speed by measuring revolution per minute (RPM), and a sensor for detecting the vehicle speed by using a global positioning system (GPS).

The image sensor 115 may obtain an image including a lane, may detect lane information from the obtained image, and may transmit the lane information to the processor 120. The image sensor 115 may include all of various sensors for photographing an image, such as a camera.

The acceleration sensor 116 measures lateral acceleration of a vehicle, but the present disclosure is not limited thereto. The acceleration sensor 116 may also measure longitudinal acceleration of a vehicle. A slip phenomenon of a tire may be detected based on the measured lateral acceleration. The surface state of a road surface may also be determined based on the measured lateral acceleration. In order to measure the lateral acceleration, it is preferred that the acceleration sensor 116 is disposed at the center of gravity of a vehicle, but the present disclosure is not essentially limited thereto.

A total of four wheel speed sensors are disposed in the wheels of a vehicle, respectively. The speed of the vehicle in addition to the rotation speed of the wheel may also be measured based on a change in the magnetic field which occurs as the wheel rotates.

Sensing information that is detected by the radar sensor 111, the yaw rate sensor 112, the steering angle sensor 113, the vehicle speed sensor 114, the image sensor 115, the acceleration sensor 116, and the wheel speed sensor may be transmitted the processor 120.

The alarm module 130 may output an alarm that provides notification of abnormal wheel alignment under the control of the processor 120. The alarm module 130 may output an alarm to a driver through a vehicle actuator or output means (e.g., an AVN device) (not illustrated) that is mounted on a vehicle. Furthermore, the alarm module 130 may be implemented by a warning lamp, for example.

The processor 120 may calculate a steering angle error indicative of a difference between a target steering angle of a vehicle and a steering angle that is detected based on lane information obtained by the sensor module 110, may calculate a rack force error indicative of a difference between a first rack force that is estimated based on information that has been fed back by a motor driven power steering system (MDPS) module of the vehicle and a second rack force that is estimated based on information including a yaw rate and lateral acceleration obtained by the sensor module 110, and may determine whether wheel alignment is abnormal based on at least one of the steering angle error and the rack force error.

When the abnormal wheel alignment is determined based on the steering angle error or the rack force error, the processor 120 may output an alarm that provides notification of the abnormal wheel alignment through the alarm module 130.

Hereinafter, an operation of the processor 120 is described in detail.

The processor 120 may calculate a steering angle error indicative of a difference between a target steering angle of a vehicle and a steering angle that is detected based on lane information obtained by the sensor module 110. In this case, the target steering angle may mean the steering angle of a steering wheel that is manipulated by a driver.

The processor 120 may detect a straight situation of a vehicle based on information on the locations of objects on a road, which are obtained by the radar sensor 111, and a yaw rate and steering angle obtained by the yaw rate sensor 112 and the steering angle sensor 113, and may calculate a steering angle error based on lane information obtained by the image sensor 115 when the detected information of the vehicle corresponds to a straight state.

Specifically, the processor 120 may detect a straight situation of a vehicle (i.e., whether a vehicle drives straight) based on information on the locations of objects on a road, which have been obtained by the radar sensor 111, and a yaw rate and a steering angle obtained by the steering angle sensor 113 and the yaw rate sensor 112 that have been mounted within the vehicle. When the vehicle is in the straight state, the processor 120 may detect a wheel alignment distortion degree (i.e., a steering angle) based on lane information obtained by the image sensor 115.

For example, if a driver attempts to drive a vehicle on a straight road in a straight line in the state in which wheel alignment of the vehicle has been distorted, the vehicle travels by being steered at an angle corresponding to a wheel alignment distortion degree in a direction opposite the direction in which the wheel alignment has been distorted. In this case, the yaw rate sensor 112 outputs a value (0 deg/s) of the straight state within an error range. The steering angle corresponds to the value of the distorted degree (i.e., an angle). Accordingly, the processor 120 detects the wheel alignment distortion degree (i.e., the angle) based on the steering angle.

When the steering angle, that is, an angle attributable to the wheel alignment distortion, is detected, the processor 120 may calculate a steering angle error indicative of a difference between a target steering angle and a detected steering angle according to a driver's manipulation of a steering wheel.

In order to determine abnormal wheel alignment, the processor 120 may calculate a rack force error indicative of a difference between a first rack force that is estimated based on information that has been fed back by the MDPS module (not illustrated) of a vehicle and a second rack force that is estimated based on information including a yaw rate and lateral acceleration obtained by the sensor module 110.

The MDPS module controls an actual vehicle (i.e., a motor) based on a received control current value. The sensor module 110 may detect an actual steering angle (Theta(θ)), an actual steering angular velocity (omega(ω)), and an actual current (Current(i)) from the MDPS module.

In order to estimate a rack force through the MDPS module, it is important to estimate a load or friction. The processor 120 may estimate the first rack force based on information that is detected by the MDPS module.

The processor 120 may estimate the first rack force by receiving a control current value that is applied to the MDPS module or a voltage value (u(Vᵢₙ)) corresponding to the control current value and also receiving the actual steering angle (Theta(θ)), the actual steering angular velocity (omega(ω)), and the actual current (Current(i)) that are detected by the sensor module 110.

A method of estimating, by the processor 120, the first rack force is illustrated in detail in FIG. 2. FIG. 2 is an exemplary diagram of an equation that is applied to a load estimation model that is used to calculate an estimated load (\hat{τ}). In this case, the equation illustrated in FIG. 2 has been illustrated in order to show that the estimated load (\hat{τ}) may be calculated. It is to be noted that the calculation of the estimated load is not limited to the equation. Referring to FIG. 2, the load estimation model is indicated by \dot{X}=AX+Bu and Y=CX. A indicates a state parameter. B indicates an input parameter. u indicates an input. X indicates a state variable. Y indicates an output. C indicates a relation between the state variable and the output.

In FIG. 2, “\hat{ }(hat)” means an estimated value. “˜ (tilde)” indicates a difference (i.e., an error) between an actual value and a reference value. Furthermore, each of L₁ to L₄ is a gain value for predicting each state variable. The gain value is adjusted through tuning, or is determined suitably for characteristics of a model that controls the gain value based on a desired bandwidth or tracking performance (i.e., considering how sensitively the gain value will respond to disturbance or noise). Furthermore, Kₜ means a motor constant, J means moment of Inertia, B means a damping coefficient, R means electrical resistance, L means inductance, and Kb means a torque constant by a counter electromotive force.

Accordingly, the processor 120 may estimate the first rack force by using Equation 1 illustrated in FIG. 2.

$$θ \text{?} = \hat{w} + {L}_{1} \tilde{θ} \qquad ( 1 )$$

$$w \text{?} = \frac{K \text{?}}{J} \text{?} - \frac{B}{J} \hat{w} + \frac{1}{J} \hat{τ} + {L}_{2} \tilde{w} \to$$

$$\text{?} = - \frac{R}{L} \text{?} \frac{{K}_{b}}{L} \hat{w} + \frac{1}{L} {v}_{in} + {L}_{3} \text{?} ↔ \tilde{θ}$$

$$\to$$

$$\text{?} \text{indicates text missing or illegible when filed}$$

That is, in Equation 1, the first rack force may be calculated in a closed loop form in real time by integrating a differential value (\hat{x}) of an estimated load quantity in equation \textcircled{4} and applying equation \textcircled{4} to equation \textcircled{2} again.

Furthermore, the processor 120 may estimate the second rack force based on information including a yaw rate and a lateral acceleration obtained by the sensor module 110. In this case, the processor 120 may estimate the second rack force by using a model equation of a preset rack force estimation model based on a yaw rate value and a lateral acceleration value that have been detected by the sensor module 110 and set information.

Specifically, the processor 120 may estimate the second rack force by using set data based on the yaw rate and lateral acceleration of a vehicle, which are detected by the sensor module 110, as vehicle state information. In this case, the set data may include the rack force estimation model that is set for the estimation of a rack force. The processor 120 may calculate and estimate the second rack force, based on a yaw rate and lateral acceleration, and vehicle-unique value information, that is, known set information, by using a model equation (may be a bicycle model equation) of the rack force estimation model.

A method of estimating the second rack force will be described with reference to FIG. 3. FIG. 3 is a diagram for describing the rack force estimation model. The processor 120 may estimate the second rack force by using Equation 2, that is, a model equation of the rack force estimation model, such as that illustrated in FIG. 3.

$$\sum {F}_{y} : m ( \text{?} + \text{?} ω \text{?} ) = {F}_{yf} + {F}_{yr} \qquad ( 2 )$$

$$\text{?} \text{indicates text missing or illegible when filed}$$

In this case, F_{y} indicates the second rack force, m indicates a vehicle weight, Vx indicates a vehicle speed, V_{y} indicates lateral acceleration, W_{z} indicates a yaw rate that is measured by the yaw rate sensor 112, F_{yf} indicates a front lateral force, and F_{yr} may mean a rear lateral force.

The processor 120 may estimate the second rack force by using the model equation of the preset rack force estimation model based on the yaw rate, the lateral acceleration, and the vehicle speed that are detected by the sensor module 110.

When the first rack force and the second rack force are estimated, the processor 120 may calculate a rack force error indicative of a difference between the first rack force and the second rack force.

When a steering angle error and a rack force error are calculated, the processor 120 may determine that wheel alignment is abnormal based on at least one of the steering angle error and the rack force error.

That is, the processor 120 may compare the steering angle error with a preset reference steering angle error range, and may determine that wheel alignment is abnormal when the steering angle error falls outside the reference steering angle error range. Furthermore, the processor 120 may compare the rack force error with a preset reference rack force error range, and may determine that wheel alignment is abnormal when the rack force error falls outside the reference rack force error range.

When the wheel alignment is determined to be abnormal due to the steering angle error or the rack force error, the processor 120 may output an alarm that provides notification of the abnormal wheel alignment through the alarm module 130. In this case, the processor 120 may differently output the alarm depending on the number of determinations of the abnormal wheel alignment attributable to the steering angle error and the rack force error. For example, when the wheel alignment is determined to be abnormal due to only the steering angle error or when the wheel alignment is determined to be abnormal due to only the rack force error, the processor 120 may output a yellow warning lamp as the alarm. Furthermore, when the wheel alignment is determined to be abnormal due to the steering angle error and the wheel alignment is determined to be abnormal due to the rack force error, the processor 120 may output a red warning lamp as the alarm.

Furthermore, the processor 120 may output information on the abnormal wheel alignment by using an alarm module (e.g., a warning lamp) and may also record and transmit an OBD fault signal so that whether a vehicle is abnormal can be simply checked.

The processor 120 may control an overall operating state of the apparatus 100 for detecting abnormal wheel alignment. The processor 120 may mean a data processing device, which has a circuit physically structured in order to perform a function that is expressed in the form of a code or instruction included in a program and which is embedded in hardware, for example. Examples of the data processing device embedded in hardware as described above may include all of processing devices, such as a microprocessor, a central processing unit (CPU), a processor core, a multiprocessor, an application-specific integrated circuit (ASIC), and a field programmable gate array (FPGA), but the scope of the present disclosure is not limited thereto.

In the motor driven power steering system (MDPS) (EPS), a steering wheel (or a column) and a gear box are connected by a unit called a U-joint. Accordingly, if a vehicle does not travel in its intended direction because a wheel connected to the gear box does not move straight even at straight steering of the steering wheel, a driver subjectively determines such a situation as abnormal wheel alignment. However, if the apparatus 100 for detecting abnormal wheel alignment according to an embodiment of the present disclosure is used, whether wheel alignment in a vehicle is abnormal can be determined based on objective data, which may be advantageous for a driver.

Furthermore, in a steer by wire (SBW) system, a wheel connected to the gear box is made to move straight by modifying the steering angle of a steering wheel through correction logic although abnormality occurs in wheel alignment because a mechanical connection is not present between the column and the gear box. In this case, it is difficult for a driver to recognize whether wheel alignment is abnormal. Furthermore, a problem, such as that a fault is accelerated because a vehicle performs an abnormal operation, may occur. However, if the apparatus 100 for detecting abnormal wheel alignment according to an embodiment of the present disclosure is used, a problem which may occur due to abnormal wheel alignment can be rapidly handled and repaired because a driver is notified of whether wheel alignment in a vehicle is abnormal or the vehicle itself determines whether wheel alignment is abnormal so that a repair center can easily know the abnormal wheel alignment.

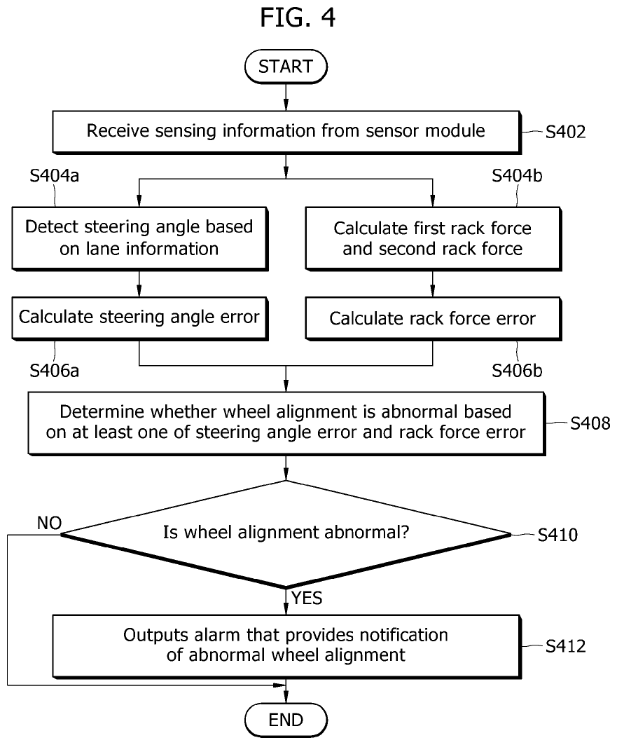

FIG. 4 is a flowchart for describing a method of detecting abnormal wheel alignment according to an embodiment of the present disclosure.

Referring to FIG. 4, the processor 120 receives sensing information from the sensor module 110 (S402). In this case, the sensing information may include a target steering angle, an actual steering angle, actual steering angle acceleration, a yaw rate, lane information, a current, lateral acceleration, a vehicle speed, a front lateral force, and a rear lateral force.

When step S402 is performed, the processor 120 detects a steering angle based on the lane information obtained by the sensor module 110 (S404a), and calculates a steering angle error indicative of a difference between the detected steering angle and a target steering angle (S406a). That is, the processor 120 may detect a straight situation of a vehicle (i.e., whether a vehicle moves straight) based on the locations of objects on a road, which have been obtained by the radar sensor 111, and a yaw rate and a steering angle obtained by the steering angle sensor 113 and the yaw rate sensor 112 mounted within the vehicle. If the vehicle is in the straight state, the processor 120 may detect a wheel alignment distortion degree (i.e., a steering angle) based on lane information obtained by the image sensor 115. Thereafter, the processor 120 may calculate a steering angle error indicative of a difference between a target steering angle according to a driver's manipulation of a steering wheel and the detected steering angle.

When step S402 is performed, the processor 120 calculate a first rack force and a second rack force (S404b) based on the sensing information obtained by the sensor module 110, and calculates a rack force error indicative of a difference between the first rack force and the second rack force (S406b). At this time, the processor 120 may estimate the first rack force by using an actual steering angle, an actual steering angular velocity, and an actual current that are fed back by the MDPS module (not illustrated) of the vehicle. Furthermore, the processor 120 may estimate the second rack force by using the model equation of the preset rack force estimation model based on a yaw rate value and a lateral acceleration value that have been detected by the sensor module 110 and set information.

When the steering angle error and the rack force error are calculated, the processor 120 determines whether wheel alignment is abnormal based on at least one of the steering angle error and the rack force error (S408). In this case, the processor 120 may compare the steering angle error with a preset reference steering angle error range, and may determine that wheel alignment is abnormal when the steering angle error falls outside the reference steering angle error range. Furthermore, the processor 120 may compare the rack force error with a preset reference rack force error range, and may determine that wheel alignment is abnormal when the rack force error falls outside the reference rack force error range.

When the wheel alignment is determined to be abnormal (S410) as a result of the determination in step S408, the processor 120 outputs an alarm that provides notification of the abnormal wheel alignment (S412). In this case, the processor 120 may differently output the alarm depending on the number of determinations of the abnormal wheel alignment attributable to the steering angle error and the rack force error. For example, when the wheel alignment is determined to be abnormal due to only the steering angle error or when the wheel alignment is determined to be abnormal due to only the rack force error, the processor 120 may output a yellow warning lamp as the alarm. Furthermore, when the wheel alignment is determined to be abnormal due to the steering angle error and the wheel alignment is determined to be abnormal due to the rack force error, the processor 120 may output a red warning lamp as the alarm.

As described above, the apparatus and method for detecting abnormal wheel alignment according to an aspect of the present disclosure detects whether wheel alignment (e.g., distortion) in a vehicle is abnormal, and notifies a driver of whether wheel alignment is abnormal or enables the driver to check whether wheel alignment is abnormal based the results of an OBD check. Accordingly, there are effects in that a driver can simply check whether wheel alignment is abnormal, a fault in a vehicle can be objectively determined and a driver can be notified of the fault, and the fault can be repaired cheaply and rapidly.

Furthermore, the apparatus and method for detecting abnormal wheel alignment according to an aspect of the present disclosure outputs information on a wheel alignment distortion by using the alarm module (e.g., a warning lamp) or transmits an OBD fault signal. Accordingly, it is advantageous from a viewpoint of vehicle maintenance and repair. Furthermore, there is an effect in that a burden of a vehicle manufacturer relating to an accident which may occur due to a corresponding fault can be reduced because a driver is previously notified of a driving performance fault situation attributable to abnormal wheel alignment in autonomous driving.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. An apparatus for detecting abnormal wheel alignment, the apparatus comprising:
a sensor module; and
a processor operatively connected to the sensor module,
wherein the processor is configured to:
determine a steering angle error including a difference between a target steering angle of a vehicle and a steering angle of the vehicle that has been detected based on lane information obtained by the sensor module,
determine a rack force error including a difference between a first rack force estimated based on information that has been fed back by a motor driven power steering system (MDPS) module of the vehicle and a second rack force estimated based on information including a yaw rate and a lateral acceleration obtained by the sensor module, and
determine whether wheel alignment is abnormal based on at least one of the steering angle error and the rack force error.

2. The apparatus of claim 1, wherein the processor is further configured to:
detect a straight situation of the vehicle based on information on locations of objects on a road, which have been obtained by a radar sensor of the sensor module in the vehicle, and the yaw rate and a steering angle obtained by the sensor module, and
determine the steering angle error based on lane information obtained by an image sensor of the sensor module operatively connected to the processor in a situation that the lane information of the vehicle corresponds to a straight state.

3. The apparatus of claim 1, wherein the processor is further configured to estimate the first rack force based on a preset equation by receiving an actual steering angle, an actual steering angular velocity, and an actual current that have been detected by the MDPS module through the sensor module.

4. The apparatus of claim 1, wherein the processor is further configured to estimate the second rack force by using a model equation of a preset rack force estimation model based on the yaw rate, the lateral acceleration, and a vehicle speed that have been detected by the sensor module.

5. The apparatus of claim 1, wherein the processor is further configured to:
compare the steering angle error with a preset reference steering angle error range and determine that the wheel alignment is abnormal in response that the steering angle error falls outside the reference steering angle error range.

6. The apparatus of claim 1, wherein the processor is further configured to:
compare the rack force error with a preset reference rack force error range and determine that the wheel alignment is abnormal in response that the rack force error falls outside the reference rack force error range.

7. The apparatus of claim 1, further including an alarm module operatively connected to the processor,
wherein the processor is configured to output an alarm that provides notification of the abnormal wheel alignment through the alarm module in response that the wheel alignment is determined to be abnormal due to at least one of the steering angle error and the rack force error.

8. The apparatus of claim 7,
wherein the processor is configured to output a first alarm that provides notification of the abnormal wheel alignment through the alarm module in response that the wheel alignment is determined to be abnormal due to the steering angle error or the rack force error.

9. The apparatus of claim 8,
wherein the processor is configured to output a second alarm that provides notification of the abnormal wheel alignment through the alarm module in response that the wheel alignment is determined to be abnormal due to the steering angle error and the rack force error, and
wherein the second alarm is different from the first alarm.

10. A method of detecting abnormal wheel alignment, comprising:
receiving, by a processor, sensing information from a sensor module operatively connected to the processor;
determining, by the processor, a steering angle error including a difference between a detected steering angle and a target steering angle based on lane information included in the sensing information and determining a rack force error including a difference between a first rack force estimated based on information that has been fed back by a motor driven power steering system (MDPS) module of a vehicle and a second rack force estimated based on a yaw rate and a lateral acceleration included in the sensing information; and
determining, by the processor, whether wheel alignment is abnormal based on at least one of the steering angle error and the rack force error.

11. The method of claim 10, wherein in the determining of the rack force error, the processor is further configured to:
detect a straight situation of the vehicle based on information on locations of objects on a road, which have been obtained by a radar sensor of the sensor module in the vehicle, and the yaw rate and a steering angle obtained by the sensor module,
determine the steering angle error based on lane information obtained by an image sensor of the sensor module operatively connected to the processor in response that the lane information of the vehicle corresponds to a straight state,
estimate the first rack force based on a preset equation by receiving an actual steering angle, an actual steering angular velocity, and an actual current that have been detected by the MDPS module through the sensor module,
estimate the second rack force by using a model equation of a preset rack force estimation model based on the yaw rate, the lateral acceleration, and a vehicle speed that have been detected by the sensor module, and
determine the rack force error between the first rack force and the second rack force.

12. The method of claim 10, wherein in the determining of whether the wheel alignment is abnormal, the processor is further configured to:
compare the steering angle error with a preset reference steering angle error range and determine that the wheel alignment is abnormal in response that the steering angle error falls outside the reference steering angle error range.

13. The method of claim 10, wherein in the determining of whether the wheel alignment is abnormal, the processor is further configured to:
compare the rack force error with a preset reference rack force error range and determine that the wheel alignment is abnormal in response that the rack force error falls outside the reference rack force error range.

14. The method of claim 10, further including:
outputting, by the processor, an alarm that provides notification of the abnormal wheel alignment through the alarm module in response that the wheel alignment is determined to be abnormal due to at least one of the steering angle error and the rack force error, after the determining of whether the wheel alignment is abnormal.

15. The method of claim 14,
wherein the processor is configured to output a first alarm that provides notification of the abnormal wheel alignment through the alarm module in response that the wheel alignment is determined to be abnormal due to the steering angle error or the rack force error.

16. The method of claim 15,
wherein the processor is configured to output a second alarm that provides notification of the abnormal wheel alignment through the alarm module in response that the wheel alignment is determined to be abnormal due to the steering angle error or the rack force error, and
wherein the second alarm is different from the first alarm.
